(19) United States
(12) Patent Application Publication
(10) Pub. No.: US 2026/0158478 A1
(43) Pub. Date: Jun. 11, 2026

(54) TUNGSTEN-MODIFIED HZSM-5 CATALYSTS AND METHODS FOR THEIR PREPARATION

(71) Applicant: PT Harapan Interaksi Swadaya, Banten, ID (US)

(72) Inventors: Sugianto Tandio, Jakarta Selatan (ID); Tommy Tjiptadjaja, Jakarta Selatan (ID); Hardaning Pranamuda, Jawa Barat (ID); Eman Suryana, Banten (ID); Daffa Dewa Saputra, Daerah Istimewa Yogyakarta (ID); Rochmadi Rochmadi, Daerah Istimewa Yogyakarta (ID); Iman Prasetyo, Daerah Istimewa Yogyakarta (ID); Teguh Ariyanto, Daerah Istimewa Yogyakarta (ID); Dhea Atika Risnawati, Daerah Istimewa Yogyakarta (ID); Nova Yoga Pradana, Banten (ID)

(73) Assignee: PT Harapan Interaksi Swadaya, Banten (ID)

(21) Appl. No.: 19/368,148

(22) Filed: Oct. 24, 2025

(30) Foreign Application Priority Data
Oct. 28, 2024 (ID) P00202411926
Oct. 28, 2024 (ID) P00202411927

(51) Int. Cl. B01J 29/48; B01J 20/02; B01J 20/18; B01J 20/30; B01J 20/32; C01B 39/40

(52) U.S. Cl. CPC B01J 29/48; B01J 20/0218; B01J 20/186; B01J 20/3078; B01J 20/3236; C01B 39/40; B01J 2229/18

(57) ABSTRACT

A method of preparing an impregnated catalyst including heating a HZSM-5 material at a temperature of from 50° C. to 60° C. in a vacuum having a pressure of −0.5 bar; dripping a solution of a tungsten-containing compound into the HZSM-5 material at a temperature of 50° C. to impregnate tungsten metal from the tungsten-containing compound into the HZSM-5 material and form the impregnated catalyst so that a ratio of tungsten metal contained in the HZSM-5 material is from 0.1% weight/weight to 2% weight/weight; keeping the impregnated catalyst for 24 hours at room temperature and atmospheric pressure; drying the impregnated catalyst in an oven for 24 hours at a temperature of from 60° C. to 70° C.; and calcining the impregnated catalyst by heating at a heating rate of 2° C./minute until the impregnated catalyst reaches a temperature of 350° C. and then maintaining the impregnated catalyst at a temperature of 350° C.

### CROSS-REFERENCE TO RELATED APPLICATIONS

This application claims priority to, and the benefit of, Indonesian Patent Application No. P00202411926, filed Oct. 28, 2024, and Indonesian Patent Application No. P00202411927, filed Oct. 28, 2024, which are hereby incorporated by reference in their entirety.

### TECHNICAL FIELD

The present disclosure relates to a method of preparing an impregnated catalyst. More specifically, the present disclosure relates to preparing impregnated aluminosilicate zeolite catalysts, particularly to HZSM-5 catalysts modified with tungsten-containing compounds. In particular, the present disclosure relates to the preparation of HZSM-5 catalysts, modified with phosphotungstic acid, that can be used to catalyze the process of producing ethylene from ethanol.

### INTRODUCTION

Ether compounds and unsaturated hydrocarbons are important organic compounds in the industrial field. One of the essential compounds in the unsaturated hydrocarbon group is ethylene, which has an important role in the chemical and manufacturing industries. Ethylene is used as the main raw material in the production of various chemicals and polymers, such as polyethylene, polyvinyl chloride, polystyrene, and ethylene oxide. One method for producing ethylene is through hydrocarbon thermal cracking processes, i.e. by heating raw materials, such as natural gas or petroleum feedstocks, at high temperatures and thereby resulting in a chemical reaction that produces ethylene. However, the production of ethylene by hydrocarbon thermal cracking method is highly dependent on non-renewable natural resources. Furthermore, this method of ethylene production generates greenhouse gas emissions, contributing to global warming.

The production of ethylene can be achieved through a recently developed method involving ethanol dehydration. This new method has the potential to reduce the negative impact of ethylene production on the environment by using ethanol raw materials from biomass feedstocks. This method uses a catalyst to break down ethanol molecules into ethylene and water. The catalytic dehydration of ethanol involves the use of a catalyst to catalyze the dehydration reaction of ethanol into ethylene and water. One such catalyst is HZSM-5. The HZSM-5 catalyst is effective in producing ethylene with high selectivity at relatively high reaction temperatures, i.e. above 300° C. At high temperatures, however, the catalytic reaction using this HZSM-5 catalyst is susceptible to catalyst deactivation due to the formation of coke, which shortens the HZSM-5 catalyst's lifespan. On the other hand, at lower reaction temperatures, the performance of the HZSM-5 catalyst in producing ethylene will decrease.

Prior art includes various attempts to improve the performance of the HZSM-5 catalyst in the dehydration process of ethanol to ethylene. One of these attempts is disclosed in Chinese Patent CN101274286A. Disclosed in the Chinese Patent document CN101274286A is the modification of the HZSM-5 catalyst by impregnating active metals into the HZSM-5 catalyst with a ratio range of from 0.5% wt/wt to 7% wt/wt. The active metals used for the impregnation include Ca, Fe, Zn, Mn, Zr, and La. Within operating conditions at atmospheric pressure and at a temperature range of from 250° C. to 290° C., it is mentioned that the modified HZSM-5 catalyst was capable of achieving 96-99% ethanol conversion with 98%-99% ethylene selectivity.

Although the modification of the HZSM-5 catalyst according to the Chinese Patent CN101274286A is mentioned to be able to increase the conversion of ethanol into ethylene and the selectivity of ethylene, the reaction temperature is still relatively high, which is from around 250° C. to around 290° C. The high reaction temperature indicates that the dehydration reaction of ethanol to ethylene using the modified HZSM-5 as disclosed in the Chinese Patent CN101274286A required a relatively high energy consumption. For that reason, alternative modifications to the HZSM-5 catalyst are still needed to make a modified HZSM-5 catalyst able to catalyze the dehydration reaction of ethanol to ethylene at lower reaction temperatures while maintaining a high level of ethanol conversion and ethylene selectivity.

The main objective of the present disclosure is to solve the technical problems related to the performance of HZSM-5 catalyst in its use to catalyze the dehydration reaction of ethanol to ethylene. Another objective of the present disclosure is to offer an alternative modification of HZSM-5 catalyst, especially for catalyzing the dehydration reaction of ethanol to ethylene.

### SUMMARY

The present disclosure aims to overcome the problems relating to the performance of HZSM-5 catalyst, especially HZSM-5 catalyst used in the dehydration reaction of ethanol to ethylene. This objective can be achieved through a method of preparing HZSM-5 catalyst impregnated by a tungsten-containing compound according to the present disclosure.

A method of preparing an impregnated catalyst includes heating a HZSM-5 material at a temperature of from 50° C. to 60° C. in a vacuum having a pressure of −0.5 bar. The method also includes dripping a solution of a tungsten-containing compound into the HZSM-5 material at a temperature of 50° C. to impregnate tungsten metal from the tungsten-containing compound into the HZSM-5 material and form the impregnated catalyst so that a ratio of tungsten metal contained in the HZSM-5 material is from 0.1% weight/weight to 2% weight/weight. The method further includes keeping the impregnated catalyst for 24 hours at room temperature and atmospheric pressure. In addition, the method includes drying the impregnated catalyst in an oven for 24 hours at a temperature of from 60° C. to 70° C. The method also includes calcining the impregnated catalyst by heating at a heating rate of 2° C./minute until the impregnated catalyst reaches a temperature of 350° C. and then maintaining the impregnated catalyst at a temperature of 350° C.

In one embodiment, the method may further include mixing the tungsten-containing compound and distilled water.

In another embodiment, drying may occur at a temperature of 60° C.

In an additional embodiment, the tungsten-containing compound may be selected from a heteropolyacid and salt forms of the heteropolyacid.

In a further embodiment, the tungsten-containing compound may be selected from phosphotungstic acid, silicotungstic acid, tungstic acid, and salt forms of the heteropolyacid.

In one embodiment, the tungsten-containing compound may be phosphotungstic acid having a chemical formula of H₃PW₁₂O₄₀.

In another embodiment, the ratio of tungsten metal contained in the HZSM-5 material may be from 0.9% wt/wt to 1.1% wt/wt.

In an additional embodiment, the HZSM-5 material before dripping may have a Si/Al ratio of from 30 to 62.

In a further embodiment, the Si/Al ratio may be from 32 to 38.

In one embodiment, a HZSM-5 catalyst impregnated with the tungsten-containing compound may be prepared by the method.

In another embodiment, the method of preparing HZSM-5 catalyst impregnated by a tungsten-containing compound according to the present disclosure includes the following steps:
a. heating a HZSM-5 material at a temperature of from 50° C. to 60° C. in a vacuum with a pressure of −0.5 bar,
b. dripping a solution of a tungsten-containing compound into the HZSM-5 material at a temperature of 50° C. to impregnate the tungsten metal from the tungsten-containing compound into the HZSM-5 material with a metal content ratio of from 0.1% weight/weight to 2% weight/weight,
c. keeping the impregnated catalyst for 24 hours at room temperature and atmospheric pressure,
d. drying the impregnated catalyst in an oven for 24 hours at a temperature of from 60° C. to 70° C., and
e. calcining the impregnated catalyst by heating at a heating rate of 2° C./minute until it reaches a temperature of 350° C. and then keeping the catalyst for a certain time at a temperature of 350° C.

In one embodiment of the present disclosure, the method of preparing the HZSM-5 catalyst impregnated by a tungsten-containing compound also includes mixing the tungsten-containing compound with distilled water.

In other embodiment of the present disclosure, the drying temperature in the method of preparing HZSM-5 catalyst containing a tungsten-containing compound is preferably 60° C.

In further embodiment of the present disclosure, the tungsten-containing compound used in the preparing the impregnated HZSM-5 catalyst said above is selected from phosphotungstic acid, silicotungstic acid, tungstic acid and salt forms of these acids. The tungsten-containing compound is preferably phosphotungstic acid, in particular, phosphotungstic acid with the chemical formula H₃PW₁₂O₄₀.

In other embodiment of the method of preparing HZSM-5 catalyst impregnated by a tungsten-containing compound, the ratio of the metal content mentioned in step b is from 0.9% wt/wt to 1.1% wt/wt.

In other embodiment of the method of preparing HZSM-5 catalyst impregnated by a tungsten-containing compound, the HZSM-5 material has a Si/Al ratio of from 30 to 62, preferably from 32 to 38.

Other embodiments of the present disclosure also include HZSM-5 catalysts impregnated with tungsten-containing compound prepared by the above mentioned methods.

### BRIEF DESCRIPTION OF THE DRAWINGS

In order to elucidate the present disclosure and to assist in understanding its advantages, this description is accompanied by the following drawings:

FIG. 1 is a flow chart showing a method for preparing a HZSM-5 catalyst impregnated by a tungsten-containing compound according to the present disclosure.

FIG. 2A is a SEM (Scanning Electron Microscopy) image showing the morphology of the HZSM-5 catalyst before being modified with phosphotungstic acid.

FIG. 2B shows the results of quantitative analysis using the ZAF Method Standardless Quantitative Analyses on the HZSM-5 catalyst before being modified with phosphotungstic acid.

FIG. 3A is a SEM image showing the morphology of the HZSM-5 catalyst after modification with phosphotungstic acid.

FIG. 3B shows the results of quantitative analysis using the ZAF method on the HZSM-5 catalyst before and after modification with phosphotungstic acid.

FIG. 4 is a product gas analysis profile curve of the catalytic dehydration reaction of ethanol using HZSM-5 catalyst impregnated by phosphotungstic acid according to the present disclosure at four different temperatures, namely 220° C., 260° C., 280° C., and 300° C.

### DESCRIPTION

The present disclosure relates to a method of preparing a modified catalyst, namely an HZSM-5 catalyst modified with a tungsten-containing compound through wet impregnation of the tungsten-containing compound into the HZSM-5 catalyst material. The present disclosure uses ZSM-5 (Zeolite Socony Mobile-5) that has been activated into HZSM-5 and tungsten metal (wolfram) obtained from the tungsten-containing compound. This modified catalyst can be used, among others, for the catalytic dehydration reaction of alcohol compounds into ethylene, ether compounds and/or unsaturated hydrocarbons.

Tungsten compounds or tungsten-containing compounds that can be used to modify the HZSM-5 catalyst according to the present disclosure include phosphotungstic acid (phosphorus-tungsten heteropolyacid) (such as H₃PW₁₂O₄₀, H₆P₂W₂₁O₇₁, and H₆P₂W₁₈O₆₂), tungstic acid H₂WO₄, silicotungstic acid (silica-tungsten heteropolyacid), such as H₄SiW₁₂O₄₀, and the salt forms of these acids.

In one embodiment of the present disclosure, the tungsten-containing compound used to modify (impregnate) the HZSM-5 catalyst is phosphotungstic acid. The selection of phosphotungstic acid as a modifying agent for the HZSM-5 catalyst is based on its excellent ability as a proton donor. Additionally, phosphotungstic acid has good thermal stability that makes it suitable for use at high temperatures. In the reaction of ethanol to ethylene, for example, tungsten metal (W) from the tungsten-containing compound acts as a co-catalyst, enhancing the catalytic activity of the aluminum sites already present in HZSM-5. The two metals exhibit analogous functions as Brønsted acid sites, which serve as the active centers for the catalytic reaction. However, W metal may exhibit greater activity than Al metal at low temperatures. The addition of W as an acid site enables the catalytic reaction to occur at a lower temperature compared to that utilizing HZSM-5 alone.

In one embodiment of the present disclosure, a tungsten-containing HZSM-5 catalyst (W/HZSM-5) is provided, prepared by impregnating phosphotungstic acid onto an HZSM-5 support material. Preferably, the tungsten-containing HZSM-5 catalyst is used for the catalytic dehydration reaction of ethanol into ethylene. The preparation of the HZSM-5 impregnated with tungsten catalyst (W/HZSM-5) is carried out through a wet impregnation process of phosphotungstic acid solution (H₃PW₁₂O₄₀) on HZSM-5 particles. The results of the impregnation process are then calcined at a temperature of 350° C. to remove the solvent used and activate the catalytic sites.

The present disclosure provides a W/HZSM-5 catalyst having a tungsten loading ranging from 0.1% by weight to 2% by weight, preferably 1% by weight. This catalyst exhibits high activity at temperatures between 220° C. and 300° C., achieving an ethylene conversion exceeding 95% and a selectivity greater than 94%.

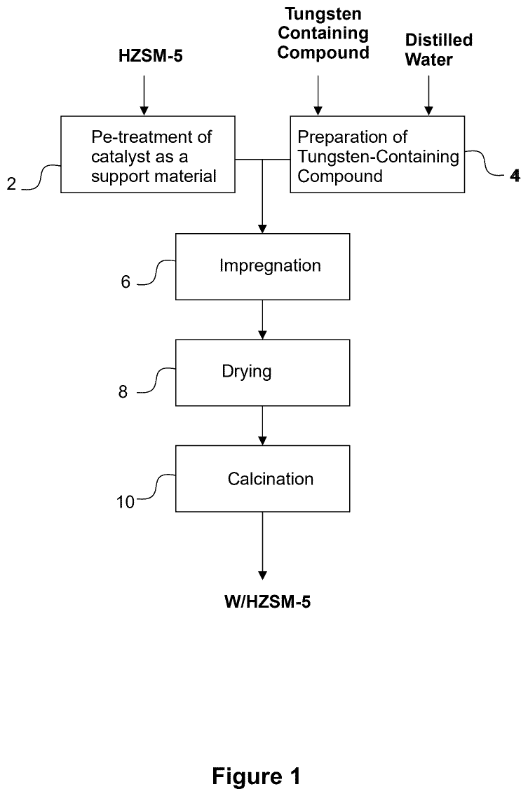

In this description, the modified catalyst prepared according to the method of the present disclosure will hereinafter be called phosphotungstic acid-impregnated HZSM-5 catalyst or abbreviated as W/HZSM-5. The method of preparing W/HZSM-5 according to the present disclosure will be described in full detail with reference to the flow chart as shown in FIG. 1.

As shown in FIG. 1, the method of preparing the W/HZSM-catalyst begins with a pre-treatment step (2) of the HZSM-5 catalyst raw material used as a support for the material to be impregnated (i.e. tungsten from tungsten-containing compounds). The HZSM-5 material used in this disclosure has a Si/Al ratio ranging from 30-62, preferably 32-38. At this step, the HZSM-5 material, initially in pellet form, is subjected to a size reduction process until uniform pellets with a length of approximately 5 mm-10 mm are obtained. Afterwards, the HZSM-5 material that has been cut into pieces is heated at a temperature of from 50° C. to 60° C. and a vacuum pressure of −0.5 bar. This heat and pressure treatment takes place for about 15 minutes. Meanwhile, the preparation step of the impregnating material (4) is also carried out. In this preparation step (4), the tungsten compound is dissolved in distilled water with a predetermined composition so that a ratio of tungsten metal contained in the HZSM-5 material is 0.1% weight/weight to 2% weight/weight, 0.9% weight/weight to 1.1% weight/weight, preferably 1% weight/weight. In the example embodiment of the disclosure shown in FIG. 1, the tungsten compound used is phosphotungstic acid (H₃PW₁₂O₄₀).

The impregnation step (6) is carried out after the pre-treatment step of HZSM-5 material (2) and the preparation step of impregnating material (4) is completed. The impregnation is conducted by dripping phosphotungstic acid solution into the HZSM-5 material at a temperature of 50° C. and atmospheric pressure. Subsequently, the HZSM-5 material that has been completely wetted is held at a temperature of 50° C. The impregnated material is then kept at room temperature and atmospheric pressure for 24 hours.

After the impregnation step (6), the next step of the W/HZSM-5 catalyst preparation method according to the present disclosure is the drying step (8). In the drying step (8), the HZSM-5 material that has been impregnated with phosphotungstic acid is completely dried in a drying oven at a temperature of from 60° C. to 70° C. for 24 hours. The next step is the calcination step (10). In this calcination step (10), the HZSM-5 material that has been impregnated with phosphotungstic acid and dried is heated at a heating rate of 2° C./min until it reaches a temperature of 350° C. The material is then maintained at a temperature of 350° C.

The HZSM-5 catalyst plays a role in protonating the hydroxyl group (OH)— which is then converted into water molecules (H₂O). The conjugate base of the catalyst then releases protons (H+) from the methyl group to form ethylene. The presence of tungsten metal (W) from phosphotungstic acid accelerates this process.

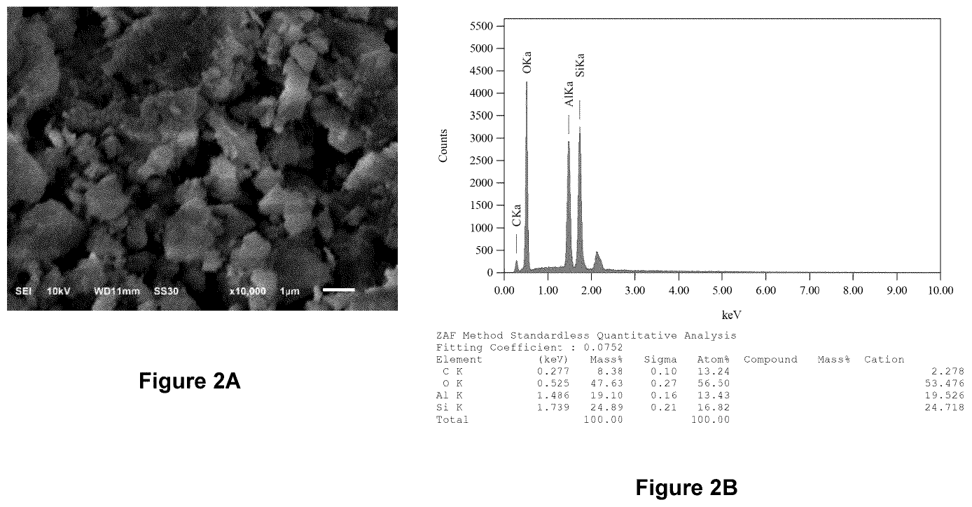

A phosphotungstic-acid-impregnated HZSM-5 catalyst (W/HZSM-5) was obtained by the preparation method as mentioned above, and surface characterization, pore structure analysis, and elemental distribution tests were conducted on the catalyst using SEM (Scanning Electron Microscopy) and EDX (Energy-Dispersive X-ray Spectroscopy) instruments. The SEM instrument depicted the sample surface through scanning using high-energy electron beams in a raster scan pattern. FIG. 2A shows the SEM image with a magnification of 10000×, and FIG. 2B shows the results of the analysis using the EDX tool for the HZSM-5 material before being modified with phosphotungstic acid. Based on the results of the EDX analysis, it can be seen that HZSM-5 contains the elements C (carbon), O (oxygen), Si (silica), and Al (alumina), and the comparison of the mass percentage of the constituent elements: C=8.38%; 0=47.63%; Si=24.89%; and Al=19.10%.

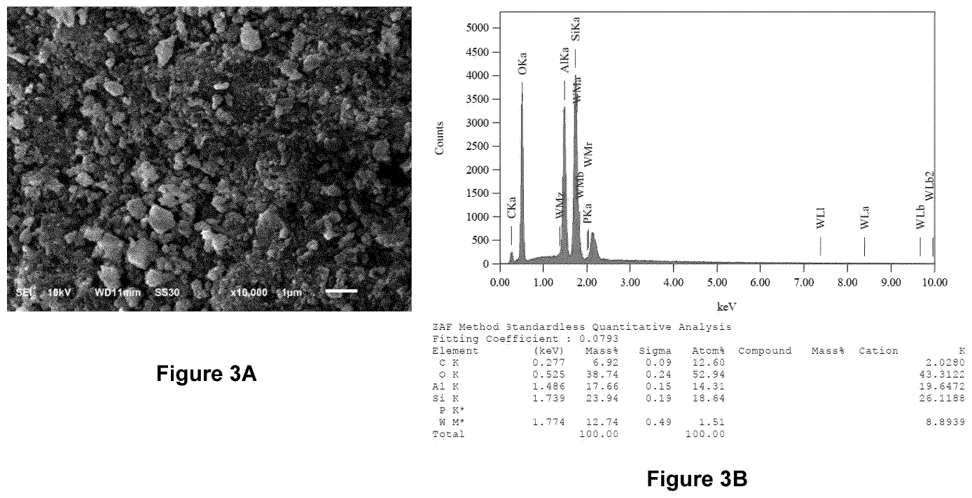

FIG. 3A shows the SEM image with 10000× magnification and EDX analysis of W/HZSM-5 material, namely HZSM-5 impregnated with phosphotungstic acid prepared by the method according to the present disclosure. Based on the EDX analysis shown in FIG. 3B, it can be seen that W/HZSM-5 contains the elements C (carbon), O (oxygen), Si (silica), Al (alumina), and W (tungsten). The mass percentage comparison of the constituent elements is as follows: C=6.92%; 0=38.74%; Si=23.94%; Al=17.66%; and W=12.74%. Furthermore, the mole percentage of the constituent elements is as follows: C=12.60%; O=52.94%; Si=18.64%; Al=14.31%; and W=1.51%.

To assess the performance of the phosphotungstic-acid-impregnated HZSM-5 prepared by the method according to the present disclosure, the catalyst was tested for the catalytic dehydration reaction of ethanol to ethylene. The test was carried out using a tubular fixed bed reactor containing 2.2 g of W/HZSM-5 catalyst material. Before the catalytic reaction process began, the W/HZSM-5 catalyst material was first flushed. Flushing was carried out by flowing nitrogen gas at a flow rate of 100 mL/min through the reactor column until no O₂, CH₄, and CO₂ gases remained.

Next, the catalytic dehydration reaction was tested by flowing ethanol vapor from a bubbler at a temperature of 62° C. using carrier nitrogen gas with a flow rate of 50 mL/min. Ethanol vapor underwent preheating, so that when it reached the catalyst bed the reaction temperature had reached several variations, namely 220° C., 240° C., 260° C., 280° C., and 300° C. The product gas was flowed through an impinger containing water to absorb the remaining unreacted ethanol vapor. Afterwards, the product gas was flowed through a condenser to purify ethylene gas from condensable gas that might still be contained in the product gas. Analysis of ethylene gas composition was carried out using a Shimadzu GC-8A type Gas Chromatography (TCD Detector Type), and analysis of residual ethanol from the solution in the impinger was conducted using a Shimadzu GC-14B type Gas Chromatography (FID Detector Type).

The test results of the catalytic dehydration reaction of ethanol into ethylene using the W/HZSM-5 catalyst are shown in Table 1 below.

TABLE 1

| Material | Ethanol Conversion (%) | | | | | Ethylene Selectivity (%) | | | | |
|---|---|---|---|---|---|---|---|---|---|---|
| Temperature | 220° C. | 240° C. | 260° C. | 280° C. | 300° C. | 220° C. | 240° C. | 260° C. | 280° C. | 300° C. |
| HZSM-5 | 51.26 | 74.33 | 69.57 | 69.60 | 93.82 | 0.00 | 17.53 | 30.86 | 55.76 | 92.24 |
| 1%-W/HZSM-5 | 96.20 | 97.77 | 99.93 | 99.95 | 99.93 | 94.20 | 95.55 | 99.84 | 99.90 | 99.88 |

*Overall WHSV: 1.8/hour; Ethanol WHSV: 0.3/hour

From Table 1, it can be seen that the W/HZSM-5 catalyst prepared by the method according to the present disclosure produced an ethanol conversion of above 96% with an ethylene selectivity of above 94% for a reaction operating temperature of from 220° C. to 300° C. The variation of HZSM-5-based catalyst modification at various reaction temperatures is also shown in Table 1.

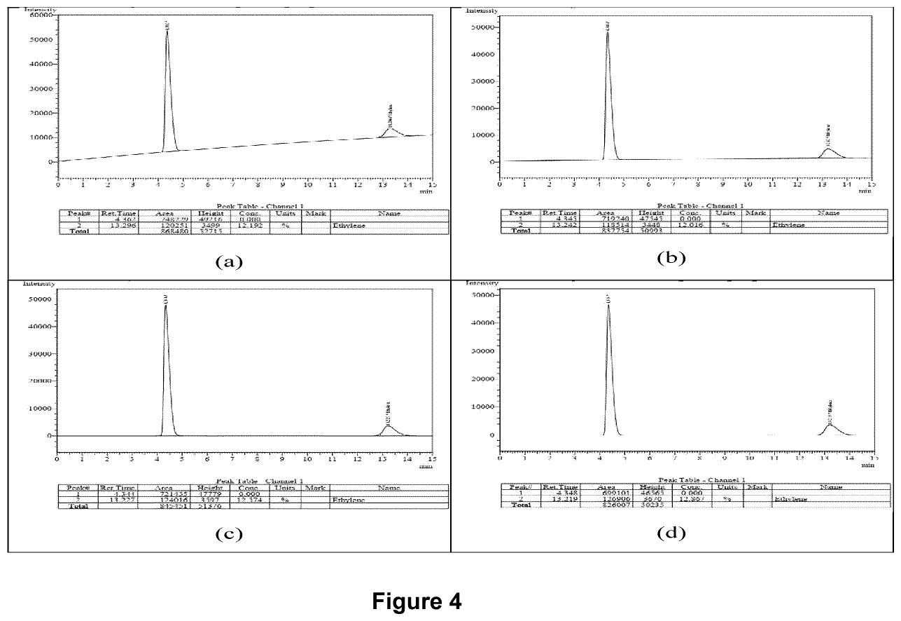

The profile analysis curve of gas produced in the catalytic dehydration reaction of ethanol using the W/HZSM-5 catalyst at (a) reaction temperature of 220° C., (b) reaction temperature of 260° C., (c) reaction temperature of 280° C., and (d) reaction temperature of 300° C. are shown in FIG. 4.

As briefly mentioned before, the use of the tungsten compound-supported HZSM-5 catalyst (W/HZSM-5) according to the present disclosure is not limited to the catalytic dehydration reaction of ethanol into ethylene, but may also be used to catalyze the dehydration reaction of alcohol into ether and/or unsaturated hydrocarbons.

In summary, the present disclosure aims to solve the technical problems related to the performance of HZSM-5 catalyst, especially in catalyzing the dehydration reaction of alcohol to ethylene, ether and/or unsaturated hydrocarbons. This objective is achieved through a method for preparing HZSM-5 catalyst impregnated by a tungsten-containing compound with the following steps:
a. heating a HZSM-5 material at a temperature of from 50° C. to 60° C. in a vacuum with a pressure of −0.5 bar,
b. dripping phosphotungstic acid solution into the HZSM-5 material at a temperature of 50° C. to impregnate the tungsten metal from the phosphotungstic acid into the HZSM-5 material with a metal content ratio of 0.1% weight/weight to 2% weight/weight,
c. keeping the impregnated catalyst for 24 hours at room temperature and atmospheric pressure,
d. drying the impregnated catalyst in an oven for 24 hours at a temperature of from 60° C. to 70° C., and
e. calcining the impregnated catalyst by heating at a heating rate of 2° C./minute until it reaches a temperature of 350° C. and then keeping the catalyst for a certain time at a temperature of 350° C.

The tungsten-containing compound is preferably phosphotungstic acid, the metal content ratio mentioned in step b is preferably 0.9% wt/wt to 1.1% wt/wt, and the Si/Al ratio of the HZSM-5 material is preferably in the range of from 32 to 38.

The description above is solely for the purpose of explaining how the method according to the disclosure prepares HZSM-5 catalysts modified with tungsten-containing compound, in particular HZSM-5 catalysts impregnated with phosphotungstic acid (W/HZSM-5). The scope of the present disclosure is, therefore, not limited to the above description. The scope of the present disclosure is set forth in the claims below.

The described embodiments of the present disclosure are intended to serve as non-limiting examples, and other embodiments may take various and alternative forms. In addition, the appended drawings are not necessarily to scale, and may present a somewhat simplified representation of various features of the present disclosure, including, for example, specific dimensions, orientations, locations, and shapes. Details associated with such features will be determined in part by the intended application and use environment of the described embodiments.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function. In addition, the use of ordinals such as first, second and third does not necessarily imply a ranked sense of order, but rather may merely distinguish between multiple instances of an act or structure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A method of preparing an impregnated catalyst, the method comprising:
heating a HZSM-5 material at a temperature of from 50° C. to 60° C. in a vacuum having a pressure of −0.5 bar;
dripping a solution of a tungsten-containing compound into the HZSM-5 material at a temperature of 50° C. to impregnate tungsten metal from the tungsten-containing compound into the HZSM-5 material and form the impregnated catalyst so that a ratio of tungsten metal contained in the HZSM-5 material is from 0.1% weight/weight to 2% weight/weight;
keeping the impregnated catalyst for 24 hours at room temperature and atmospheric pressure;
drying the impregnated catalyst in an oven for 24 hours at a temperature of from 60° C. to 70° C.; and
calcining the impregnated catalyst by heating at a heating rate of 2° C./minute until the impregnated catalyst reaches a temperature of 350° C. and then maintaining the impregnated catalyst at a temperature of 350° C.

2. The method of claim 1, further including mixing the tungsten-containing compound and distilled water.

3. The method of claim 1, wherein drying occurs at a temperature of 60° C.

4. The method of claim 1, wherein the tungsten-containing compound is selected from a heteropolyacid and salt forms of the heteropolyacid.

5. The method of claim 4, wherein the tungsten-containing compound is selected from phosphotungstic acid, silicotungstic acid, tungstic acid, and salt forms of the heteropolyacid.

6. The method of claim 5, wherein the tungsten-containing compound is phosphotungstic acid having a chemical formula of H₃PW₁₂O₄₀.

7. The method of claim 1, wherein the ratio of tungsten metal contained in the HZSM-5 material is from 0.9% wt/wt to 1.1% wt/wt.

8. The method of claim 1, wherein the HZSM-5 material before dripping has a Si/Al ratio of from 30 to 62.

9. The method according to claim 8, wherein the Si/Al ratio is from 32 to 38.

10. A HZSM-5 catalyst impregnated with the tungsten-containing compound prepared by the method of claim 1.
